(19) United States
(12) Patent Application Publication
(10) Pub. No.: US 2013/0119979 A1
(43) Pub. Date: May 16, 2013

(54) LEAKAGE FLUX PROBE FOR NON-DESTRUCTIVE LEAKAGE FLUX-TESTING OF BODIES CONSISTING OF MAGNETIZABLE MATERIAL

(71) Applicant: V & M Deutschland GmbH, Duesseldorf (DE)

(72) Inventors: Michael Kaack, Bochum (DE); Gert Fischer, Wachtendonk (DE); Oliver Nemitz, Duisburg (DE); Till Schmitte, Bochum (DE); Stefan Nitsche, Muelheim (DE)

(73) Assignee: V & M DEUTSCHLAND GMBH, Duesseldorf (DE)

(21) Appl. No.: 13/676,448

(22) Filed: Nov. 14, 2012

(30) Foreign Application Priority Data
Nov. 16, 2011 (DE) 10 2011 055 409.2

(51) Int. Cl. G01N 27/82

(52) U.S. Cl. CPC G01N 27/82
USPC 324/242

(57) ABSTRACT

A leakage flux probe for non-destructive leakage flux-testing of bodies consisting of magnetizable material, in particular of pipes consisting of ferromagnetic steel, having a plurality of sensors disposed one behind the other in a straight line for detection of near-surface flaws in the body. In order to create a leakage flux probe for non-destructive leakage flux-testing of bodies consisting of magnetizable material, in particular of pipes consisting of ferromagnetic steel, which in a main testing direction has a broadened directional characteristic. At least two similar sensors are disposed and interconnected in a sensor package in a different angular orientation with respect to the main testing direction one above the other, one next to the other or one lying inside the other. The sensor packages disposed generally in a line one behind the other can be influenced individually by the generated leakage flux of an existing flaw. The individual sensors of the sensor package are spaced apart from each other by such a small spaced interval that the interconnected sensors of a sensor package are collectively influenced by the generated leakage flux of an existing flaw.

### BACKGROUND OF THE INVENTION

The invention relates to a leakage flux probe for non-destructive leakage flux-testing of bodies consisting of magnetizable material, such as pipes consisting of ferromagnetic steel.

For the purpose of non-destructive and near-surface testing of bodies consisting of magnetizable materials, it is generally known to use the so-called leakage flux method. For this purpose, the bodies which are to be tested are magnetized temporarily by electromagnets, cylinder coils or current linkage. In a homogeneous and flawless ferromagnetic material, the magnetic field lines are distributed uniformly over the surface. If the homogeneity of the material is disrupted by near-surface discontinuities, such as, e.g., cracks, cavities, inclusions, pores or laminations, then magnetic field lines can emerge as so-called leakage flux outside the workpiece in the region of the discontinuities. This leakage flux can be detected in a contacting or contactless manner by probes. A corresponding testing device typically includes a magnetization unit, a handling unit for the body to be tested, a testing shoe having the leakage flux probes, an evaluating unit and optionally a demagnetization unit. Leakage flux probes used for measuring the magnetic leakage flux density include, e.g., induction coils, Giant-Magneto-Resistance sensors (GMR-sensors), Anisotropic-Magneto-Resistant sensors (AMR), Tunneling-Magneto-Resistant sensors (TMR) or Hall-sensors.

This known leakage flux-testing is also applied, e.g., in the case of pipes consisting of ferromagnetic steel, in order to detect longitudinally and transversely oriented, as seen in the longitudinal direction of the pipes, discontinuities and discontinuities on the inner and outer surfaces.

During testing, unidirectional field magnetization of the pipe is typically used, since flaws on the outer surface and on the inner surface of the pipe can be detected thereby. Alternating field magnetization, which is used, e.g., in the case of bar stock, can generally only detect flaws on the outer surface.

Flaws which are located on the outer or inner surface of the pipe can be caused by different factors. They can be caused, e.g., by faulty inner tools or rollers or even by flaws in the basic material. The leakage flux-testing renders it possible to localize and identify flaws at an early stage, as a consequence of which, in accordance with corresponding corrective measures, high failure rates and post-processing rates can be obviated.

In order to test the pipe for longitudinal flaws, a magnetic field is applied at right angles to the longitudinal axis of the pipe, which means that its magnetic field lines are oriented at right angles to the longitudinal extension of a longitudinal flaw extending ideally in the longitudinal direction of the pipe. Therefore, during longitudinal flaw testing, the magnetic field lines extend in the circumferential direction of the pipe. In connection with longitudinal flaw testing, the circumferential direction of the pipe is then also designated as the main testing direction. For transverse flaw testing, a magnetic field is applied in parallel with the longitudinal axis of the pipe, which means that its magnetic field lines are oriented at right angles to the longitudinal extension of a transverse flaw extending ideally in the circumferential direction of the pipe. Therefore, the magnetic field lines extend in the longitudinal direction of the pipe in the case of transverse flaw testing. In connection with transverse flaw testing, the longitudinal direction of the pipe is then also designated as the main testing direction. Depending on whether longitudinal or transverse flaw testing is now being carried out, there is always a main testing direction, but it is one which extends depending on the type of testing either in the circumferential direction of the pipe or in the longitudinal direction of the pipe. If only oblique flaws are to be specifically investigated, then the main testing direction is at a corresponding angular position with respect to the longitudinal axis or circumferential direction of the pipe.

In order to detect the entire surface when testing for longitudinal flaws in the pipe, the pipe and the probe may be moved in helical fashion with respect to each other. Typically, when testing for transverse flaws, a probe having a sensor ring is fixedly positioned around the pipe and serves to move the pipe in the longitudinal direction. In order to calibrate the testing device, one or several grooves introduced onto a reference workpiece are used as a test flaw reference. The grooves simulate longitudinal, oblique and transverse flaws.

The German patent specification DE 198 23 453 C2 already discloses a leakage flux probe for non-destructive testing of elongate and rotationally symmetrical bodies, in particular pipes, for longitudinal or transverse flaws. The leakage flux probe consists substantially of a ruler-shaped printed circuit board, a so-called sensor ruler, on whose side facing the body to be tested a plurality of coil pairs as sensors are printed. A total of 16 coil pairs are provided which as seen in the longitudinal direction of the printed circuit board are disposed in succession at a respectively identical spaced interval. Each individual coil of a coil pair comprises an elongate, substantially running track-like winding, i.e., each winding is ring-shaped in an elongate manner having a central longitudinal axis. The coils of a coil pair are each disposed slightly obliquely in relation to the longitudinal direction of the printed circuit board, so that in each case the longitudinal axis of the coils and the longitudinal direction of the printed circuit board form approximately an angle of 10°. Moreover, as seen in the longitudinal direction of the printed circuit board, both coils of a pair are disposed laterally next to each other at a spaced interval and are offset with respect to each other in the longitudinal direction of the printed circuit board, so that as seen in the longitudinal direction of the printed circuit board the right-hand coil of a pair protrudes approximately two thirds of the length of the coil with respect to the left-hand coil. In this case, the coils of a pair are inclined to the right.

With the known leakage flux-testing, two mutually separate testing devices are used to reliably identify any longitudinal flaws in a first test and transverse flaws in a second test. In the case of the respective test, the magnetic field is introduced into the test body in each case in the main testing direction, perpendicular to the longitudinal or transverse flaws which are to be detected, wherein the individual coil pairs are each detected separately from the generated leakage flux field of a discontinuity. The orientation of the magnetic field is always in the main testing direction of the pipe.

However, in the case of longitudinal and transverse flaw testing, oblique flaws extending obliquely with respect to the magnetic field direction are only identified to a limited extent, since the sensitivity (directional characteristic) of the individual sensors rapidly decreases as the oblique position of the flaw increases. Similarly, oblique flaw testing in which the main testing direction is, e.g., at an angle of 45° in relation to the longitudinal axis of the pipe, is typically not suitable for also detecting longitudinal and transverse flaws to the same degree.

Furthermore, laid-open document US 2011/0167914 A1 discloses a testing device which can travel in a laid oil or gas line and which has a large number of sensors for non-destructive testing of the wall of the oil or gas lines from the inside. The sensors also include leakage flux probes which, as seen in the longitudinal direction of the testing device, are disposed radially in groups with a plurality of groups one behind the other. The leakage flux probes of the individual groups can have their directional characteristic differently oriented in relation to the longitudinal direction of the oil or gas line to be tested.

### SUMMARY OF THE INVENTION

The present invention provides a leakage flux probe for non-destructive leakage flux-testing of bodies consisting of magnetizable material, in particular of pipes consisting of ferromagnetic steel, which probe, in relation to a main testing direction, has a broadened directional characteristic and, therefore, also detects flaws which are not optimally oriented with respect to the main testing direction with the most uniform possible signal strength.

A leakage flux probe for non-destructive leakage flux-testing of a body generally made up of magnetizable material, according to an aspect of the invention, has a plurality of sensors for detection of near-surface flaws in the body including a plurality of sensor packages. Each sensor package has at least two of the sensors being disposed and interconnected in a different angular orientation with respect to a testing direction. The at least two of said sensors are oriented one above the other, one next to the other or one lying inside the other in that sensor package. The sensor packages are disposed one behind the other wherein the sensor packages can be influenced individually by the generated leakage flux of an existing flaw. The at least two sensors are spaced apart from each other by a sufficiently small spaced interval that said at least two sensors are collectively influenced by the generated leakage flux of an existing flaw.

Each sensor package may have at least three of the sensors. The at least three of the sensors making up one of said sensor packages may be electrically connected to each other serially or in parallel. The at least three of the sensors may be formed as elongate annular coils. The at least three of the sensors making up one of the sensor packages may be electrically connected to each other serially or in parallel. The at least three of the sensors may be formed as induction coils, GMR-sensors, AMR-sensors, TMR-sensors or Hall-sensors.

The at least two of the sensors making up one of said sensor packages may be electrically connected to each other serially or in parallel. The at least two of the sensors may be formed as induction coils, GMR-sensors, AMR-sensors, TMR-sensors or Hall-sensors. The at least two of the sensors may be formed as elongate annular coils. The at least two of the sensors making up one of the sensor packages may be formed as an annular coil pair which is connected electrically differentially. The at least two of the sensors may be disposed horizontally or vertically with respect to the pipe surface.

The at least two of the sensors may be disposed in a sensor package in an angular range of approximately −90° to +90° about the main testing direction. The at least two of the sensors may be disposed in a sensor package in an angular range of approximately −60° to +60° about the main testing direction. The at least two of the sensors may be disposed in the sensor package in an angular range of approximately −45° to +45° about the main testing direction. The at least two of the sensors may be disposed in a said sensor package in an angular range of approximately −30° to +30° about the main testing direction.

The at least two of the sensors of one of the sensor packages may be imprinted on a printed circuit board. The at least two of the sensors of one of the sensor packages may be disposed one above the other on a multi-layering technique. Individual ones of the at least two of the sensors of one of the sensor packages may be calibrated in relation to a mutual sensitivity value using a resistance network. The at least two of the sensors of one of the sensor packages may be made up of induction coils that are calibrated in relation to a mutual sensitivity by adapting a number of windings and/or the coil surface of the induction coils.

A magnetization unit may be included. The magnetization unit is adapted to provide a magnetic field to the body which is to be tested. The magnetization unit may be adapted to provide a unidirectional or alternating magnetic field that is oriented with its field lines perpendicularly in the circumferential direction in parallel with a longitudinal axis in the pipe or at an angle of between approximately 0° and 90° with respect to the pipe axis.

A leakage flux probe will be understood hereinafter as being an arrangement consisting of a plurality of leakage flux probes, which in the manner of a ruler, i.e., in a straight line one behind the other, consists of a plurality of leakage flux probes, wherein in accordance with the invention the individual sensors are replaced by sensor packages.

In accordance with an aspect of the invention, in the case of a leakage flux probe for non-destructive leakage flux-testing of bodies consisting of magnetizable material, in particular of pipes consisting of ferromagnetic steel, having a plurality of sensors disposed one behind the other in a straight line for detection of near-surface flaws in the body, in relation to a main testing direction a broadened directional characteristic is achieved by virtue of the fact that at least two similar sensors are disposed and interconnected in a different angular orientation with respect to the main testing direction one above the other, one next to the other or one lying inside the other as a sensor package, that sensor packages which are disposed one behind the other can be influenced individually by the generated leakage flux of an existing flaw and the individual sensors of the sensor package are spaced apart from each other by such a small spaced interval that the interconnected sensors of a sensor package are collectively influenced by the generated leakage flux of an existing flaw. Therefore, flaws which are not optimally oriented with respect to the main testing direction are also detected with the most uniform possible signal strength. In connection with the present invention, the term main testing direction is understood as previously described in conjunction with the prior art.

A probe of this type can be used for transverse or longitudinal flaw testing and in so doing also detect oblique flaws in a broadened angular range. The main testing directions lie in these cases in the direction of the pipe axis or perpendicular thereto. In principle, however, the orientation of the main testing direction is not limited. It is thus feasible with, e.g., the main testing direction of 45° with respect to the pipe axis and with a directional characteristic which spans, e.g., 30°, to carry out a test for oblique flaws from 30° to 60°.

An advantage of the broadened directional characteristic is, on the one hand, that it is possible to detect flaws at such oblique positions to the main testing direction which could not be detected according to the previous techniques. On the other hand, previously detectable flaws can also now be detected with a greater signal-noise ratio and, therefore, with increased likelihood of detection.

Sensors which have a different angular orientation with respect to the main testing direction are understood to mean that the detection efficiency of the sensors is dependent in each case upon the orientation of a flaw which is to be identified. The detection efficiency of the sensors thus depends upon the orientation of the sensor with respect to the position of the flaw such as, e.g., a longitudinal, oblique or transverse flaw. Each sensor thus has an optimum detection efficiency in relation to a specifically oriented flaw. In one sensor package, a plurality of sensors are used, the optimum detection efficiency of which deviates from one to the other in relation to a specifically oriented flaw. Therefore, their optimum detection angles are oriented differently with respect to each other. As a consequence, the bandwidth of the detection efficiency is increased with respect to an individual sensor.

Detecting the individual components of the leakage flux field to be detected is not necessarily essential to the probe in accordance with embodiments of the invention. Measurement including these would measure, e.g., the longitudinal, transverse and the radial components and then evaluate them. Instead, with the probe, the directional characteristic of an individual sensor is increased, i.e., detects signals in a broadened angular range about the main testing direction with an improved signal-noise ratio. The simple single-channel evaluation can further be used for a single sensor—a complicated multi-channel evaluation, as for determination of the individual components, is not necessary.

These previous tests for longitudinal or transverse flaws were not able to bridge the gap with respect to the detection of oblique flaws. However, this is now possible with the leakage flux probe in accordance with embodiments of the invention.

The leakage flux probe in accordance with the invention is particularly suitable for testing for flaws in elongate and rotationally symmetrical bodies, in particular hot-rolled and seamless pipes.

By virtue of the fact that a plurality of sensors in a different angular orientation with respect to the main testing direction are combined in one sensor package and the sensors of a sensor package are collectively influenced by the magnetic leakage flux generated by a flaw, the sensor package may have a significantly broader directional characteristic compared to individual sensors or sensor pairs of a sensor ruler, so that a broad range of oblique flaws about the main testing direction of ideally −90° to +90° in relation to the longitudinal axis of the pipe can be covered by a single test for longitudinal flaws. For detection of oblique flaws, a range of −60° to +60° in relation to the main testing direction is suitable. A range of −45° to 45° can also be selected, wherein, in dependence upon the testing task, a range of −30° to 30° may also suffice.

If the directional characteristic of such a probe covers at least 90°, it is now also possible in a single step to carry out the test for longitudinal and transverse flaws with detection of obliquely extending flaws, if the magnetic field acting upon the test body is oriented at less than 45° with respect to the longitudinal or transverse flaws. This can be achieved, e.g., by means of two mutually perpendicularly oriented magnetic fields which act simultaneously upon the test body, so that an orientation of less than 45° is achieved by the superimposition of the magnetic fields.

The sensors of the sensor packages, which may be disposed in a different angular orientation, can be disposed laying one above the other in layers, one next to the other or one inside the other. The spacing between the sensors in the sensor package may be so small that the leakage flux field produced by a flaw which is to be detected influences all sensors collectively.

The sensors of the sensor package may be connected to each other serially or in parallel, wherein the sensors which can be used are, e.g., induction coils, GMR-sensors, AMR-sensors, TMR-sensors, or Hall-sensors. The advantage of such connection is in particular that the probe in accordance with the invention, like a conventional probe, emits only an output signal and conventional probes in existing testing installations can simply be interchanged without further evaluating units having to be added.

In a further embodiment, the sensors are oriented alternatively horizontally or vertically in relation to the pipe surface. The different orientations of the sensors are used for detection of the leakage field components in the radial direction or in the circumferential direction.

When induction coils are illustrated, the close proximity of the individual coils can be achieved in that for the horizontally oriented case, the coils are disposed one above the other by means of a multi-layering technique. In the case of the vertical arrangement, the coils may be interleaved one inside the other and disposed in different angular positions.

Since in comparison with GMR-sensors or Hall-sensors, induction coils are only negligibly narrower than the leakage flux fields which are to be detected, an arrangement in which the coils lie one above the other may be provided. In contrast, GMR-sensors or Hall-sensors are considerably narrower than the leakage flux field to be detected, which means that in this case an arrangement can be selected in which they are disposed lying one next to the other in a different angular orientation.

In particular, testing for longitudinal and oblique flaws will be discussed hereinafter. When horizontally oriented induction coils are used as sensors, they are formed in accordance with the invention as flat coils which are imprinted on a printed circuit board and which comprise an elongate and annular winding (elongate annular coil). The elongate annular coils have a high degree of sensitivity for longitudinal and oblique flaws. The coils of a sensor package which are disposed one above the other in layers are applied to the printed circuit board by means of a multi-layering technique. Essentially, the same is also possible for GMR-sensors or Hall-sensors.

By virtue of this innovative coil design, reliable testing for oblique flaws can also be incorporated into leakage flux-testing for longitudinal flaws or transverse flaws.

The annular coils which are disposed one above the other at different angles may be disposed next to one another in pairs and connected together. Reliable detection is achieved via a differential connection of the coils.

In the case of the test for longitudinal flaws, it is provided that the sensors in a sensor package may be oriented in stepped angular increments with respect to the main testing direction, e.g., at −30°, 0° and +30°. By virtue of these orientations, the sensitivity of the sensors is adapted to longitudinal or oblique flaws and the directional characteristic is thus broadened considerably.

In a test for longitudinal flaws on a pipe having artificial flaws in the form of grooves which were aligned at 0°, 30° and 60° with respect to the longitudinal axis of the pipe, tests showed that for detection with this orientation sufficiently high signal amplitude levels are achieved over a broad range from 0° to approximately 60°. This leakage flux probe thus permits combined longitudinal and oblique flaw testing.

Since, in the case of leakage flux-testing, flaws which are disposed perpendicularly with respect to the magnetization direction generate in principle a larger signal amplitude than flaws lying obliquely thereto, the sensor arrangement in accordance with the invention can become oversensitive in the case of a perpendicular flaw orientation. The invention can be implemented such that the sensitivity of the obliquely oriented sensors is matched to the sensors oriented perpendicularly with respect to the exciting field. In the case of the induction coils, this can be achieved by adapting the number of turns of the relevant coil and/or by adapting the coil surface and/or by changing the spaced interval. In so doing, it is even possible occasionally to dispense with the coil which is oriented perpendicularly with respect to the exciting field. In the case of GMR-sensors, AMR-sensors, TMR-sensors or Hall-sensors, but also in the case of induction probes, a corresponding adaptation can be achieved by a resistance network.

Within the scope of non-destructive leakage flux-testing, a corresponding testing device may include not only the leakage flux probe but also a magnetization unit, by means of which the body may be magnetized by a magnetic field for leakage flux-testing. The pipe which is to be magnetized may be magnetized for the leakage flux-testing by a unidirectional field and the magnetic field is oriented with its field lines perpendicular to any longitudinal flaws in the pipe. The advantage of unidirectional magnetization over alternating field magnetization resides in the fact that flaws on the outer surface and on the inner surface of the pipe can be detected thereby.

These and other objects, advantages and features of this invention will become apparent upon review of the following specification in conjunction with the drawings.

### BRIEF DESCRIPTION OF THE DRAWINGS

The invention will be explained in greater detail hereinafter with reference to an exemplified embodiment which is illustrated in several figures, in which:

FIG. 1 shows a schematic view of a device for non-destructive leakage flux testing of pipes;

FIG. 2a shows a schematic plan view of a sensor ruler of the leakage flux probes in accordance with an embodiment of the invention; and

FIG. 2b shows a side elevation view of the sensor ruler of FIG. 2a.

### DESCRIPTION OF THE PREFERRED EMBODIMENT

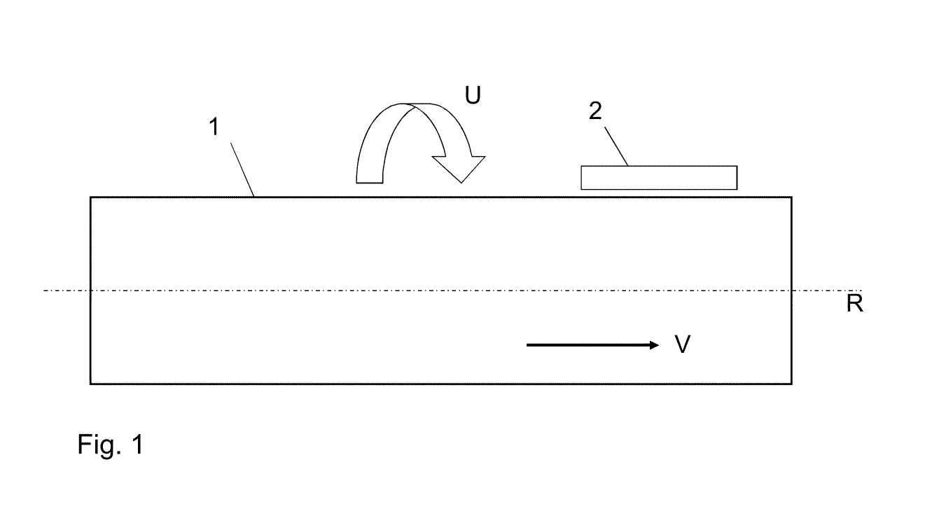

Referring now to the drawings and the illustrative embodiments depicted therein, FIG. 1 illustrates a schematic view of a device for non-destructive leakage flux-testing of a hot-rolled seamless pipe 1, made of ferromagnetic steel, for longitudinal flaws and oblique flaws. Pipe 1 typically is illustrated as having a central pipe axis R which extends in the longitudinal direction of the pipe 1. The core component of the testing device is a leakage flux probe which is part of a testing shoe 2. For testing purposes, the pipe 1 is moved in the feed direction V and the testing shoe 2 is moved in a circumferential direction U around the pipe 1, so that the pipe 1 is examined on a helical track.

The device for non-destructive leakage flux-testing includes not only a testing shoe 2 but also a magnetization unit, not illustrated, by which pipe 1 is magnetized by a magnetic field for leakage flux testing. In this case, pipe 1 is magnetized by a unidirectional field. The magnetic field is oriented with field lines perpendicular to any longitudinal flaws in the pipe 1 and thus transversely with respect to the pipe axis R in the circumferential direction of the pipe 1. The magnetic field lines are therefore oriented in a main testing direction. An advantage of unidirectional magnetization over alternating field magnetization resides in the fact that flaws on the outer surface and on the inner surface of the pipe 1 can thereby be detected.

Testing for transverse flaws is performed by a further testing shoe, not illustrated, having a correspondingly adapted leakage flux probe. The magnetization is rotated in the longitudinal direction of the pipe 1 (i.e., by 90° with respect to longitudinal flaw testing). This means that the main testing direction then extends in the longitudinal direction of the pipe 1. Accordingly, for transverse flaw testing, the sensors, sensor pairs and sensor packages are also disposed rotated by 90° with respect to longitudinal flaw testing.

In this case, flaws are understood to be near-surface discontinuities, such as, e.g., cracks, cavities, inclusions, pores or laminations. The testing shoe comprising the leakage flux probe may be part of a leakage flux-testing device which also includes a magnetization unit, a handling unit, an evaluation unit and a demagnetization unit.

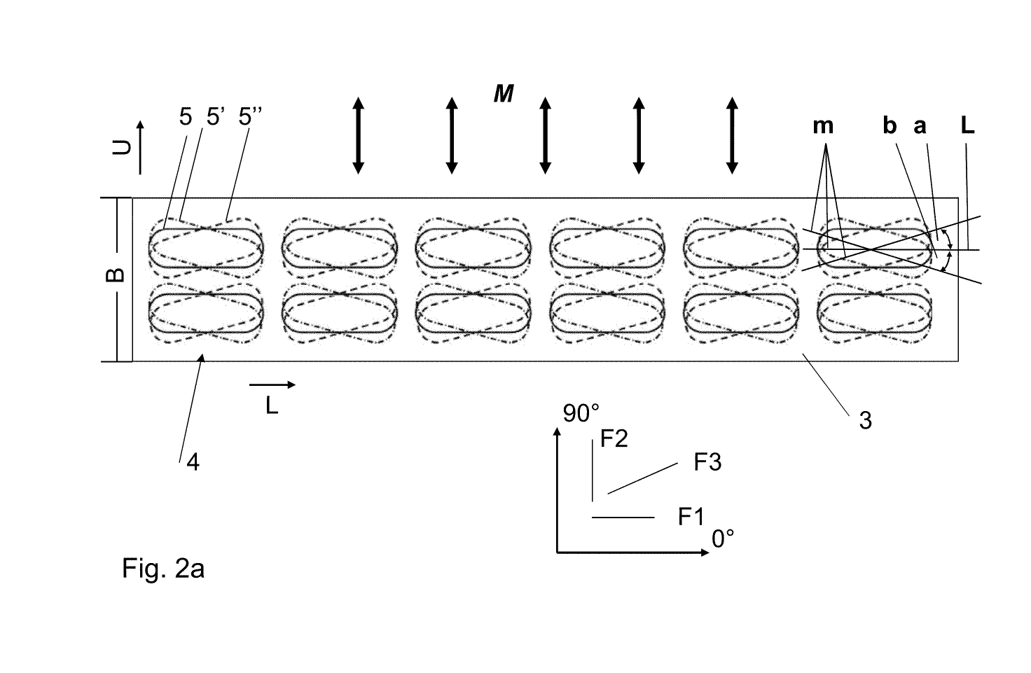

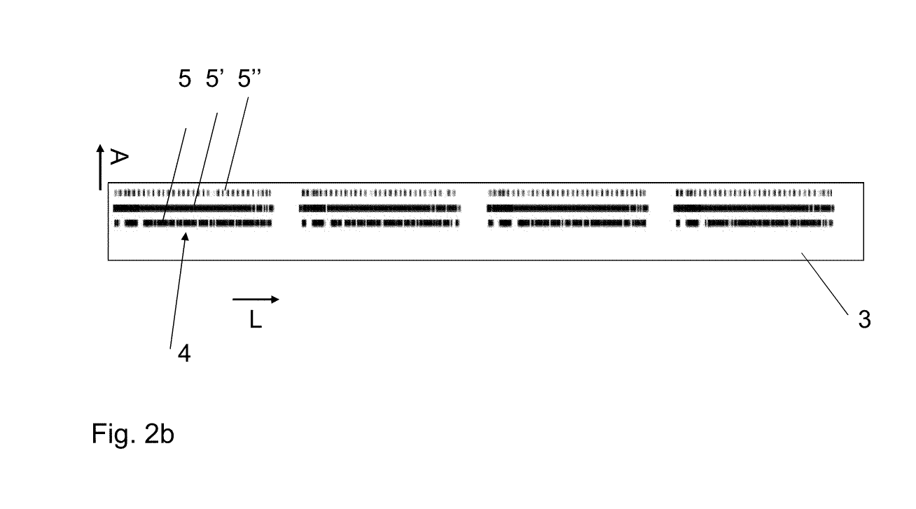

FIG. 2a illustrates a schematic plan view of a sensor ruler 3 of the leakage flux probe for non-destructive testing of hot-rolled seamless pipes, consisting of ferromagnetic steel, for longitudinal flaws and oblique flaws. The present example relates to horizontally oriented induction coils. In this case, horizontal is understood to be in parallel with the pipe axis R and therefore in parallel with the outer surface of pipe 1. The plan view illustrates the planar testing side, i.e., the side facing the body which is to be tested—in this case pipe 1. The sensor ruler 3 has an elongate, rectangular shape having a longitudinal direction L which is oriented in parallel with the pipe axis R. Imprinted on the testing side of the sensor ruler 3 are a plurality of sensor packages 4 which are disposed next to one another. Each sensor package 4 includes sensors 5, 5′, 5″ which are disposed at different angular orientations one above the other in layers by means of a multi-layering technique. As a consequence, the individual induction coils of the sensors 5, 5′, 5″ are disposed in close proximity to one another.

The sensor ruler 3 has a width B which is selected such that the sensors 5, 5′, 5″ of a sensor package 4 which are oriented at different angles with respect to the longitudinal direction L can be disposed accordingly. FIG. 2a illustrates three sensors 5, 5′, 5″ which are disposed one above the other and are formed as induction coils. The induction coils are formed as flat coils which are imprinted onto a printed circuit board and have an elongate and annular winding (elongate annular coil). The elongate annular coils have a high degree of sensitivity to longitudinal and oblique flaws. The sensors 5, 5′, 5″ have a central axis m which extends centrally and in parallel with the longitudinal extension thereof. The central axis m extends from the central sensor 5′ in parallel with the longitudinal direction L of the sensor ruler 3. The angle formed by the longitudinal direction L and the central axis m is 0 degrees. The central axis m of the lower sensor 5 extends at an angle a with respect to the longitudinal direction L of the sensor ruler 3. The angle formed by the longitudinal direction L and the central axis m is greater than 0 degrees and is preferably in the range of 1 to 20 degrees. The central axis m of the upper sensor 5 extends at an angle b with respect to the longitudinal direction L of the sensor ruler 3. The angle b formed by the longitudinal direction L and the central axis m is less than 0 degrees and is preferably in the range of −1 to −20 degrees.

Conductor tracks are imprinted on the rear side, not illustrated here, of the sensor ruler 3 lying opposite the testing side, in order to connect the individual sensors 5, 5′, 5″ of the sensor package 4 electrically to plug-in contacts which are likewise attached to the rear side of the sensor ruler 3. Each sensor package 4 is connected to a separate evaluation channel.

For the purpose of pipe testing for longitudinal flaws, the sensor ruler 3 and thus the leakage flux probe is oriented with its longitudinal direction L in parallel with a longitudinally directed pipe axis R of the pipe. The pipe axis R runs centrally in the pipe in the longitudinal direction thereof.

Typically, longitudinal flaws F1 are understood to be flaws, whose longitudinal extension runs generally in parallel, i.e., at an angle of 0°, with respect to the pipe axis R. Consequently, transverse flaws F2 run generally at right angles, i.e., at an angle of 90°, with respect to the pipe axis R. All differently oriented flaws are referred to as oblique flaws F3.

In addition to the testing shoe 2 with the leakage flux probe, the testing device also includes a magnetization unit, not illustrated here, in order to magnetize the pipe 1 temporarily with a magnetic field M. In this case, the field lines of the magnetic field M run at right angles with respect to the pipe axis R, since in the present case the testing device is designed primarily for identifying longitudinal flaws F1 and a broad range of oblique flaws F3.

From the side view of the inventive leakage flux probe, illustrated in FIG. 2b, it can be seen that the individual sensor packages 4, which are disposed one next to the other, each consist of individual induction coils as sensors 5, 5′, 5″. The coils are imprinted onto the printed circuit board of the sensor ruler 3 and are disposed one above the other in the radial direction of the pipe A.

In order to calibrate the leakage flux probe embodied herein, one or several grooves, which are introduced onto a reference workpiece, are used as a test flaw reference. The grooves simulate longitudinal, oblique and transverse flaws. The amplitude level of the measurement signals of the sensors 5, 5′, 5″ in similar test flaws—such as in this case in the form of grooves—which are situated in a different orientation with respect to the pipe axis R, depends upon the respective angular position of the grooves in the range of −90° to +90°. For example, a change in the angular position by 5° can constitute a change in the amplitude level by 10 to 20%.

Since the change in the amplitude level is a measure of the change in permeability and thus represents the relevance of a flaw or a discontinuity, the sensor package 4 having the sensors 5, 5′, 5″ which are oriented at different angular positions has a broader direction characteristic, which means that even for oblique flaws there is optimized sensitivity in relation to the ability to detect said flaws. Since in the case of leakage flux-testing flaws disposed perpendicularly with respect to the magnetization direction generate in principle a greater signal amplitude than flaws situated obliquely thereto, the sensors 5, 5′, 5″ in accordance with the invention can become oversensitive when a flaw is oriented perpendicularly. Therefore, the sensitivity of the obliquely oriented sensors 5, 5″ is matched to the sensors 5′ which are oriented perpendicularly with respect to the exciting field. In the case of the induction coils, this can be achieved by adapting the number of windings of the relevant coil and/or by adapting the coil surface and/or by changing the spaced interval. In some embodiments, the coil which is oriented perpendicularly with respect to the exciting field can even be dispensed with.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

The embodiments of the invention in which an exclusive property or privilege is claimed are defined as follows:

1. A leakage flux probe for non-destructive leakage flux-testing of a body generally made up of magnetizable material having a plurality of sensors for detection of near-surface flaws in the body, said leakage flux probe comprising:
a plurality of sensor packages, each having at least two of said sensors being disposed and interconnected in a different angular orientation with respect to a testing direction, said at least two of said sensors oriented one above the other, one next to the other or one lying inside the other in that one of said sensor packages;
said sensor packages being disposed generally in a line wherein said sensor packages can be influenced individually by the generated leakage flux of an existing flaw and said at least two of said sensors are spaced apart from each other by a sufficiently small spaced interval that said at least two sensors are collectively influenced by the generated leakage flux of an existing flaw.

2. The leakage flux probe as claimed in claim 1 wherein each said sensor package comprises at least three of said sensors.

3. The leakage flux probe as claimed in claim 1 wherein the at least two of said sensors making up one of said sensor packages are electrically connected to each other serially or in parallel.

4. The leakage flux probe as claimed in claim 1 wherein said at least two of said sensors are formed as induction coils, GMR-sensors, AMR-sensors, TMR-sensors or Hall-sensors.

5. The leakage flux probe as claimed in claim 1 wherein said at least two of said sensors are formed as elongate annular coils.

6. The leakage flux probe as claimed in claim 5 wherein the at least two of said sensors making up one of said sensor packages are formed as an annular coil pair which is connected electrically differentially.

7. The leakage flux probe as claimed in claim 1 wherein the at least two of said sensors are disposed horizontally or vertically with respect to the pipe surface.

8. The leakage flux probe as claimed in claim 1 wherein the at least two of said sensors are disposed in a said sensor package in an angular range of approximately −90° to +90° about the main testing direction.

9. The leakage flux probe as claimed in claim 1 wherein the at least two of said sensors are disposed in a said sensor package in an angular range of approximately −60° to +60° about the main testing direction.

10. The leakage flux probe as claimed in claim 1 wherein the at least two of said sensors of one of said sensor packages are imprinted on a printed circuit board.

11. The leakage flux probe as claimed in claim 10 wherein the at least two of said sensors of one of said sensor packages are disposed one above the other on a multi-layering technique.

12. The leakage flux probe as claimed in claim 1 wherein individual ones of said at least two sensors of one of said sensor packages are calibrated in relation to a mutual sensitivity value using a resistance network.

13. The leakage flux probe as claimed in claim 1 wherein said at least two of said sensors of one of said sensor packages are made up of induction coils that are calibrated in relation to a mutual sensitivity by adapting a number of windings and/or the coil surface of the induction coils.

14. The leakage flux probe as claimed in claim 1 including a magnetization unit, said magnetization unit adapted to provide a magnetic field to the body which is to be tested.

15. The leakage flux probe as claimed in claim 14 wherein said magnetization unit is adapted to provide a unidirectional or alternating magnetic field that is oriented with its field lines perpendicularly in the circumferential direction in parallel with a longitudinal axis in the pipe or at an angle of between approximately 0° and 90° with respect to the pipe axis.

16. The leakage flux probe as claimed in claim 9 wherein the at least two of said sensors are disposed in a said sensor package in an angular range of approximately −45° to +45° about the main testing direction.

17. The leakage flux probe as claimed in claim 16 wherein the at least two of said sensors are disposed in a said sensor package in an angular range of approximately −30° to +30° about the main testing direction.

18. The leakage flux probe as claimed in claim 2 wherein said at least three of said sensors making up one of said sensor packages are electrically connected to each other serially or in parallel.

19. The leakage flux probe as claimed in claim 18 wherein said at least two of said sensors are formed as induction coils, GMR-sensors, AMR-sensors, TMR-sensors or Hall-sensors.

20. The leakage flux probe as claimed in claim 2 wherein said at least three of said sensors are formed as elongate annular coils.

21. The leakage flux probe as claimed in claim 20 wherein the at least three of said sensors making up one of said sensor packages are electrically connected to each other serially or in parallel.

22. The leakage flux probe as claimed in claim 2 wherein said at least three of said sensors are formed as induction coils, GMR-sensors, AMR-sensors, TMR-sensors or Hall-sensors.
